(19) United States
(12) Patent Application Publication
(10) Pub. No.: US 2026/0122564 A1
(43) Pub. Date: Apr. 30, 2026

(54) USER-EQUIPMENT-INITIATED POWER SIGNAL THAT USES MULTIPLE NETWORK NODES

(71) Applicant: QUALCOMM Incorporated, San Diego, CA (US)

(72) Inventors: Raviteja PATCHAVA, San Diego, CA (US); Piyush GUPTA, Bridgewater, NJ (US); Junyi LI, Greentown, PA (US)

(21) Appl. No.: 18/933,094

(22) Filed: Oct. 31, 2024

(51) Int. Cl. H04W 52/02; H04L 5/00

(52) U.S. Cl. CPC H04W 52/0219; H04L 5/0048

(57) ABSTRACT

Various aspects of the present disclosure generally relate to wireless communication. In some aspects, a user equipment (UE) may transmit one or more requests to initiate transmission of a multiple-network-node power signal that uses a first network node and at least a second network node. The UE may receive the multiple-network-node power signal that uses the first network node and at least the second network node. Numerous other aspects are described.

### FIELD OF THE DISCLOSURE

Aspects of the present disclosure generally relate to wireless communication and specifically relate to techniques, apparatuses, and methods associated with a user-equipment-initiated power signal that uses multiple network nodes.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

### SUMMARY

Some aspects described herein relate to a method of wireless communication performed by a user equipment (UE). The method may include transmitting one or more requests to initiate transmission of a multiple-network-node power signal that uses a first network node and at least a second network node. The method may include receiving the multiple-network-node power signal that uses the first network node and at least the second network node.

Some aspects described herein relate to a method of wireless communication performed by a first network node. The method may include receiving a request to initiate transmission of a multiple-network-node power signal that uses the first network node and at least a second network node. The method may include communicating with at least the second network node to coordinate the transmission of the multiple-network-node power signal. The method may include transmitting at least a portion of the multiple-network-node power signal based at least in part on the communicating.

Some aspects described herein relate to an apparatus for wireless communication at a UE. The apparatus may include one or more memories and one or more processors coupled to the one or more memories. The one or more processors may be configured, individually or collectively, to transmit one or more requests to initiate transmission of a multiple-network-node power signal that uses a first network node and at least a second network node. The one or more processors may be configured, individually or collectively, to receive the multiple-network-node power signal that uses the first network node and at least the second network node.

Some aspects described herein relate to an apparatus for wireless communication at a first network node. The apparatus may include one or more memories and one or more processors coupled to the one or more memories. The one or more processors may be configured, individually or collectively, to receive a request to initiate transmission of a multiple-network-node power signal that uses the first network node and at least a second network node. The one or more processors may be configured, individually or collectively, to communicate with at least the second network node to coordinate the transmission of the multiple-network-node power signal. The one or more processors may be configured, individually or collectively, to transmit at least a portion of the multiple-network-node power signal based at least in part on the communicating.

Some aspects described herein relate to a non-transitory computer-readable medium that stores a set of instructions for wireless communication by a UE. The set of instructions, when executed by one or more processors of the UE, may cause the UE to transmit one or more requests to initiate transmission of a multiple-network-node power signal that uses a first network node and at least a second network node. The set of instructions, when executed by one or more processors of the UE, may cause the UE to receive the multiple-network-node power signal that uses the first network node and at least the second network node.

Some aspects described herein relate to a non-transitory computer-readable medium that stores a set of instructions for wireless communication by a first network node. The set of instructions, when executed by one or more processors of the first network node, may cause the first network node to receive a request to initiate transmission of a multiple-network-node power signal that uses the first network node and at least a second network node. The set of instructions, when executed by one or more processors of the first network node, may cause the first network node to communicate with at least the second network node to coordinate the transmission of the multiple-network-node power signal. The set of instructions, when executed by one or more processors of the first network node, may cause the first network node to transmit at least a portion of the multiple-network-node power signal based at least in part on the communicating.

Some aspects described herein relate to an apparatus for wireless communication. The apparatus may include means for transmitting one or more requests to initiate transmission of a multiple-network-node power signal that uses a first network node and at least a second network node. The apparatus may include means for receiving the multiple-network-node power signal that uses the first network node and at least the second network node.

Some aspects described herein relate to an apparatus for wireless communication. The apparatus may include means for receiving a request to initiate transmission of a multiple-network-node power signal that uses the first network node and at least a second network node. The apparatus may include means for communicating with at least the second network node to coordinate the transmission of the multiple-network-node power signal. The apparatus may include means for transmitting at least a portion of the multiple-network-node power signal based at least in part on the communicating.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIG. 3 is a diagram illustrating examples associated with different types of ambient Internet of Things devices, in accordance with the present disclosure.

FIG. 4 is a diagram illustrating an example associated with backscatter communications, in accordance with the present disclosure.

FIG. 5 is a diagram illustrating an example of a wireless communication process between a first network node, a user equipment (UE), and a second network node, in accordance with the present disclosure.

FIG. 6 is a diagram illustrating an example process performed, for example, at a UE or an apparatus of a UE, in accordance with the present disclosure.

FIG. 7 is a diagram illustrating an example process performed, for example, at a first network node or an apparatus of a first network node, in accordance with the present disclosure.

FIG. 8 is a diagram of an example apparatus for wireless communication, in accordance with the present disclosure.

FIG. 9 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Wireless power transfer uses electromagnetic fields to transfer power from a first device to a second device without the use of a wired connection between the devices. One example of wireless power transfer includes a network node that transmits a power signal that is received and used by an ambient Internet of Things (IoT) device, also referred to as a user equipment (UE), to harvest energy. The transmission of a power signal between devices for wireless power transfer may also be referred to as a power link. In some cases, energy harvesting by an ambient IoT device may have a reduced range relative to wireless communications. For instance, a wireless power transfer range between a network node and an ambient IoT device may be a few meters (e.g., 10 meters) due to insufficient link budget, and the insufficient link budge may be based at least in part on a variety of factors, such as receiver sensitivity, fading, path loss, and/or antenna gain. The reduced range for a power link may hinder the operation of the ambient IoT device when the reduced range results in reducing an amount of energy and/or power that is harvested by the ambient IoT device. To illustrate, less harvest power at the ambient IoT device may increase a charging duration at the ambient IoT device (e.g., a duration in which the ambient IoT device may be inoperable) and/or reduce how often the ambient IoT device has enough power to perform operations and/or communications. Alternatively, or additionally, energy harvesting circuitry may be configured to harvest energy using power signals that have a higher input power level (e.g., characterized by a high power level threshold, such as −13 decibel-milliwatts (dBm)) and power signals that have a lower input power level (e.g., characterized by a low power level threshold, such as −20 dBm) may render the energy harvesting circuitry, and consequently the ambient IoT device, inoperable. In some cases, a power signal with a low input power level may have a reduced conversion efficiency (e.g., below 1%) that not only wastes power at a network node, but extends a charging duration at the ambient IoT device.

Multiple network nodes may be deployed around an ambient IoT device to increase power transfer coverage of the ambient IoT device based at least in part on an overlap between respective power signals by the multiple network nodes. However, increasing a number of network nodes to increase power transfer coverage may not always result in an increase in harvested energy for some ambient IoT devices. Examples include an ambient device that resides at an edge of the power transfer coverage and/or an ambient IoT device positioned behind an obstruction that blocks a direct line-of-sight to the network node(s). Without coordination between the network nodes for power transfer coverage to the ambient IoT device, the ambient IoT device may continue to harvest energy at a slower rate and, in some cases, may fail to harvest energy. As described above, a slower rate of energy harvesting, and/or failing to harvest energy, may hinder the operation of the ambient IoT device by reducing how often the ambient IoT device may perform operations and/or communications that use the harvested energy.

Various aspects relate generally to a UE-initiated power signal that uses multiple network nodes. Some aspects more specifically relate to a UE (e.g., an ambient IoT device) triggering multiple network nodes to coordinate a power transfer to the UE, resulting in increased coherence gain in a power signal and, consequently, an increase an effective received power level of the power signal at the UE (e.g., relative to a power transfer signal that is transmitted by a standalone network node and is not a joint transmission by multiple network nodes). In some aspects, a UE, such as an ambient IoT device, may transmit one or more requests to initiate transmission of a multiple-network-node power signal that uses a first network node and at least a second network node. To illustrate, the UE may receive a first indication of the first network node and/or that the first network node is a potential first power supplier to the UE and a second indication of the second network node and/or that the second network node is a potential second power supplier to the UE. Accordingly, the UE may initiate a request to one or more of the network nodes to coordinate and transmit a multiple-network-node power signal. Based at least in part on transmitting the request(s), the UE may receive a multiple-network-node power signal uses the first network node and at least the second network node.

In some aspects, a first network node may receive a request to initiate transmission of a multiple-network-node power signal that uses the first network node and at least a second network node. For instance, the first network node may receive the request from a UE, and the request may identify one or more network nodes to coordinate for the multiple-network-node power signal. Accordingly, based at least in part on receiving the request, the first network node may communicate with at least the second network node to coordinate the transmission of the multiple-network-node power signal. As one example, the first network node may communicate with at least the second network node using a backhaul link and/or may indicate, via the backhaul link, to coordinate transmission of a multiple-network-node power signal to the ambient IoT device. The first network node may transmit at least a portion of the multiple-network-node power signal based at least in part on communicating with at least the second network node. To illustrate, the first network node and at least the second network node may transmit the multiple-network-node power transfer signal as a single frequency network (SFN) transmission in which the respective power transfer signals share one or more of the same time-frequency resources.

Particular aspects of the subject matter described in this disclosure can be implemented to realize one or more of the following potential advantages. In some examples, by transmitting a request to initiate transmission of a multiple-network-node power signal, the described techniques can be used to enable a UE (e.g., an ambient IoT device) to identify network nodes that are within power transfer coverage of the UE and trigger coordination between the network nodes to generate the multiple-network-node power signal in a manner that increases a coherence gain of the power signal and, consequently, a power level of a received power signal at the UE (e.g., relative to a power signal that is not a joint transmission and/or an SFN transmission). Increasing the effective received power level at the UE may enable the UE to harvest energy at a faster rate and, consequently, increase how often the UE may perform operations and/or perform communications that use the harvested energy.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, IoT networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

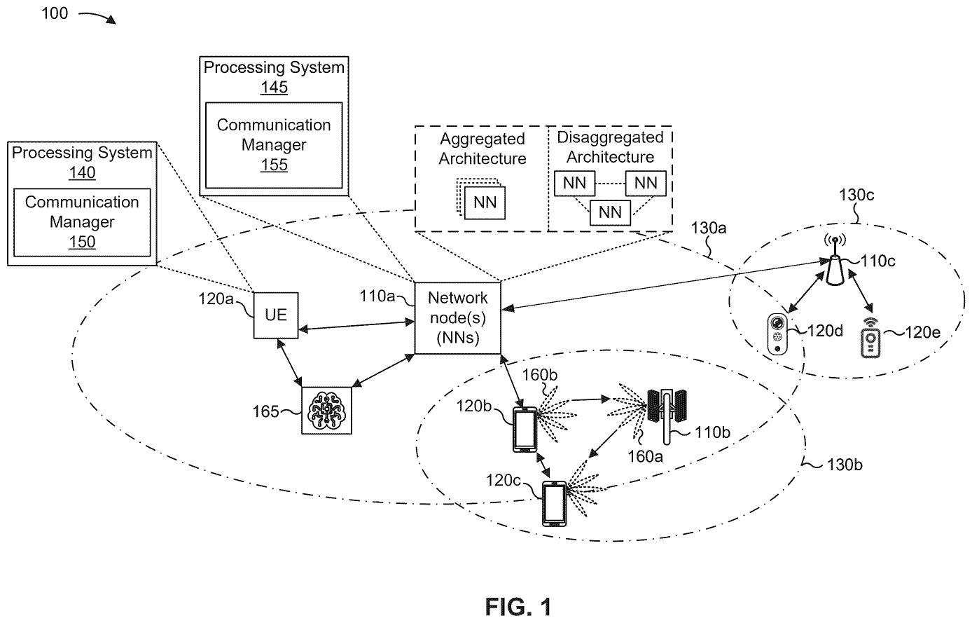

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a, a network node 110b, and a network node 110c. The network nodes 110 may support communications with multiple UEs 120. For example, in FIG. 1, the network nodes 110 support communication with a UE 120a, a UE 120b, a UE 120c, a UE 120d, and a UE 120e. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

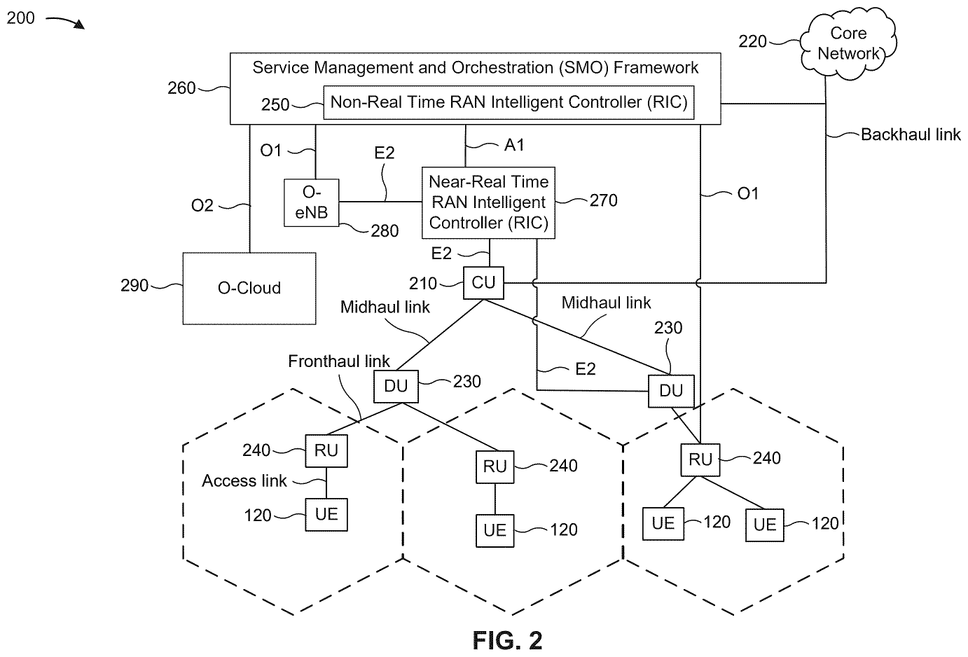

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a, a cell 130b, and a cell 130c), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot formal indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)—reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)—spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, SFN transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, a network node 110 and/or UEs 120). For example, the one or more devices 165 may include a UE 120 (for example, the processing system 140), a network node 110 (for example, the processing system 145), one or more servers, and/or one or more components of a cloud computing network, among other examples. In some examples, the AI/ML model (or an instance of the AI/ML model) may be deployed at multiple devices (for example, a first portion of the AI/ML model may be deployed at a UE 120 and a second portion of the AI/ML model may be deployed at a network node 110). In other examples, a first AI/ML model may be deployed at a UE 120 and a second AI/ML model may be deployed at a network node 110. The AI/ML model(s) may be configured to enhance various aspects of the wireless communication network 100. For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

Some UEs 120 may be considered machine-type communication (MTC) UEs, evolved or enhanced machine-type communication (eMTC) UEs, further enhanced eMTC (feMTC) UEs, or enhanced feMTC (efeMTC) UEs, or further evolutions thereof, all of which may be simply referred to as “MTC UEs.” For example, the UE 120d and/or the UE 120e may be an MTC UE. An MTC UE may be, may include, or may be included in or coupled with a robot, an uncrewed aerial vehicle, a remote device, a sensor, a meter, a monitor, and/or a location tag. Some UEs 120 may be considered IoT devices. Some such UEs 120 may be implemented as NB-IoT (narrowband IoT) devices, such as the UE 120d and/or the UE 120e. An IoT or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment (CPEs), which may include telecommunications devices that are installed at a customer location (such as a home or office) to enable access to a service provider's network (such as included in or in communication with the wireless communication network 100).

In some aspects, a UE (e.g., a UE 120) may include a communication manager 150. As described in more detail elsewhere herein, the communication manager 150 may transmit one or more requests to initiate transmission of a multiple-network-node power signal that uses a first network node and at least a second network node; and receive the multiple-network-node power signal that uses the first network node and at least the second network node. Additionally, or alternatively, the communication manager 150 may perform one or more other operations described herein.

In some aspects, a network node (e.g., a network node 110) may include a communication manager 155. As described in more detail elsewhere herein, the communication manager 155 may receive a request to initiate transmission of a multiple-network-node power signal that uses the first network node and at least a second network node; communicate with at least the second network node to coordinate the transmission of the multiple-network-node power signal; and transmit at least a portion of the multiple-network-node power signal based at least in part on the communicating. Additionally, or alternatively, the communication manager 155 may perform one or more other operations described herein.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

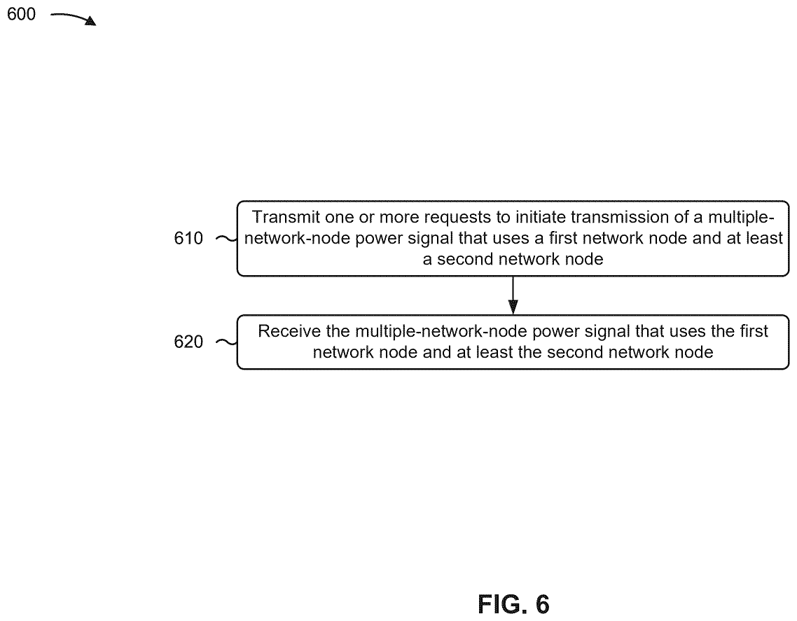

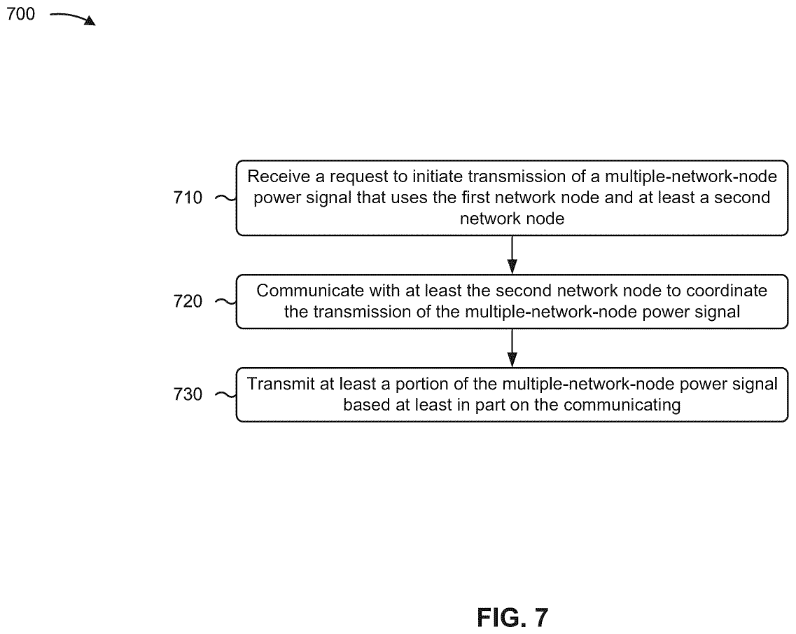

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with a UE-initiated power signal that uses multiple network nodes, as described in more detail elsewhere herein. For example, the processing system 145 of the network node 110, the processing system 140 of the UE 120, the CU 210, the DU 230, or the RU 240 may perform or direct operations of, for example, process 600 of FIG. 6, process 700 of FIG. 7, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 600 of FIG. 6, process 700 of FIG. 7, or other processes as described herein. In some examples, executing instructions may include running the instructions, converting the instructions, compiling the instructions, and/or interpreting the instructions, among other examples.

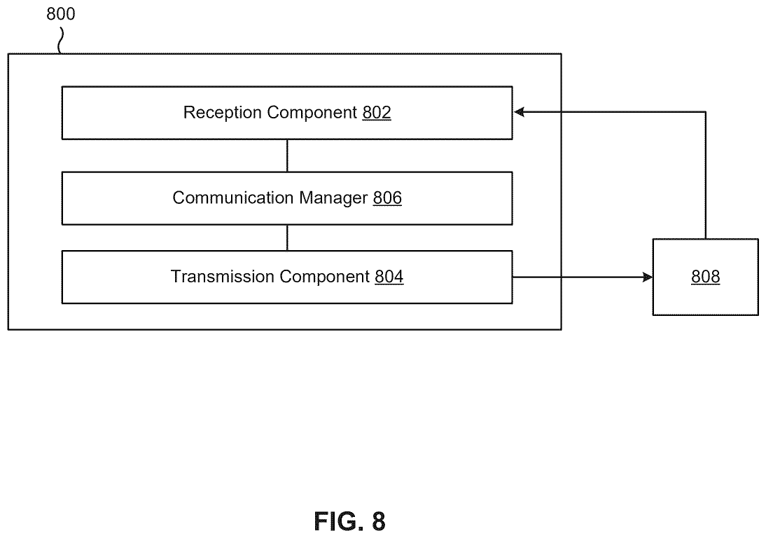

In some aspects, a UE (e.g., a UE 120) includes means for transmitting one or more requests to initiate transmission of a multiple-network-node power signal that uses a first network node and at least a second network node; and/or means for receiving the multiple-network-node power signal that uses the first network node and at least the second network node. The means for the UE to perform operations described herein may include, for example, one or more of communication manager 150, processing system 140, a radio, one or more RF chains, one or more transceivers, one or more antennas, one or more modems, a reception component (for example, reception component 802 depicted and described in connection with FIG. 8), and/or a transmission component (for example, transmission component 804 depicted and described in connection with FIG. 8), among other examples.

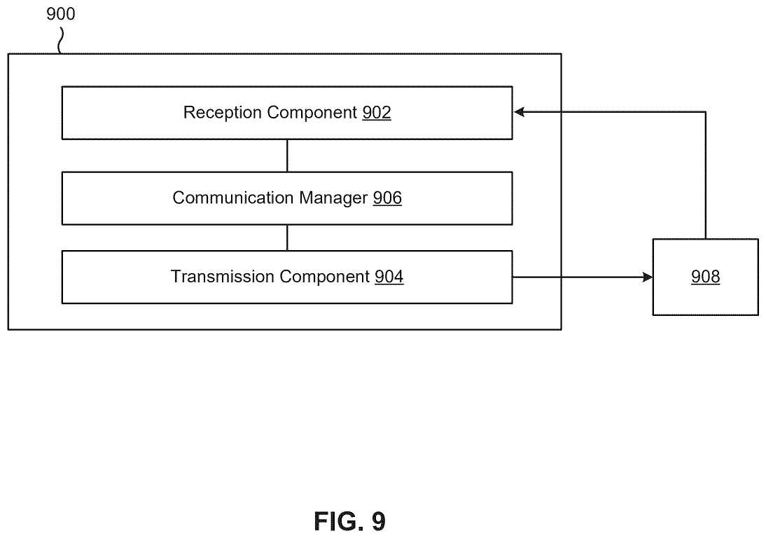

In some aspects, a first network node (e.g., a network node 110) includes means for receiving a request to initiate transmission of a multiple-network-node power signal that uses the first network node and at least a second network node; means for communicating with at least the second network node to coordinate the transmission of the multiple-network-node power signal; and/or means for transmitting at least a portion of the multiple-network-node power signal based at least in part on the communicating. The means for the first network node to perform operations described herein may include, for example, one or more of communication manager 155, processing system 145, a radio, one or more RF chains, one or more transceivers, one or more antennas, one or more modems, a reception component (for example, reception component 902 depicted and described in connection with FIG. 9), and/or a transmission component (for example, transmission component 904 depicted and described in connection with FIG. 9), among other examples.

As indicated above, FIG. 2 is provided as an example. Other examples may differ from what is described with regard to FIG. 2.

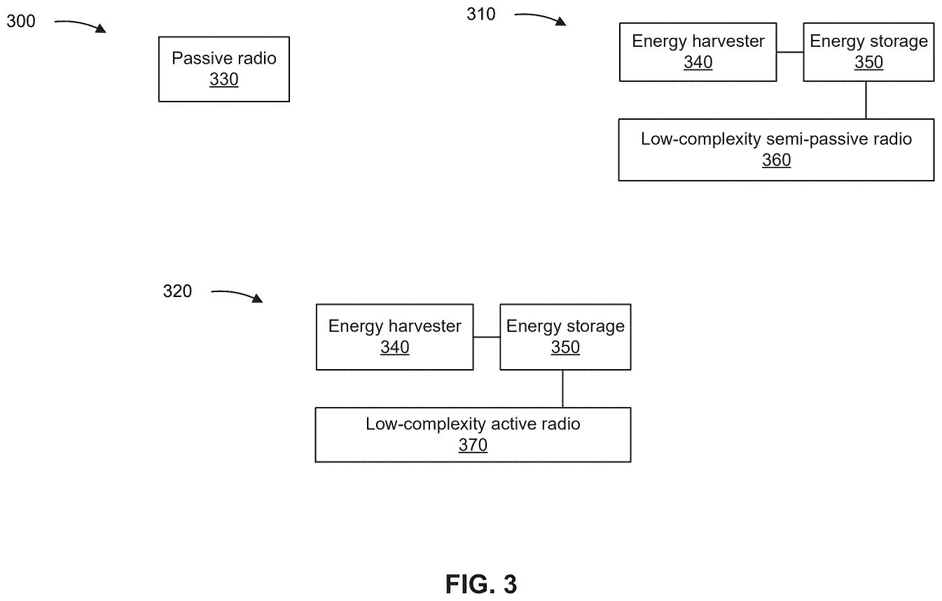

FIG. 3 is a diagram illustrating examples 300, 310, and 320 associated with different types of ambient IoT devices.

Example 300 illustrates components of a passive ambient IoT device. As shown, passive ambient IoT devices may include a passive radio 330. For example, the passive radio 330 may be configured to backscatter a carrier wave (CW).

Example 310 illustrates components of a semi-passive ambient IoT device. As shown, semi-passive ambient IoT devices may include an energy harvester 340, an energy storage 350, and/or a low-complexity semi-passive radio 360. For example, the low-complexity semi-passive radio 360 may be configured to harvest energy from a CW using the energy harvester 340, store energy from a CW using the energy storage 350, and/or backscatter a CW.

Example 320 illustrates components of an active ambient IoT device. As shown, active ambient IoT devices may include an energy harvester 340, an energy storage 350, and/or a low-complexity (for example, low-cost) active radio 370. For example, the low-complexity active radio 370 may be configured to harvest energy from a CW using the energy harvester 340, store energy from a CW using the energy storage 350, and/or backscatter a CW.

Ambient IoT devices may be categorized into at least three types of devices: device 1, device 2a, and device 2b. Device 1 type ambient IoT devices may include at least some passive and/or semi-passive devices. A device 1 type ambient IoT device may have approximately 1 μW peak power consumption, support energy storage, use an initial sampling frequency offset (SFO) up to 10× ppm (for example, where X can be any suitable value), and communicate uplink transmissions by backscattering externally-provided CWs.

Device 2a type ambient IoT devices may include at least some semi-passive devices, and device 2b type ambient IoT devices may include active devices. Both device 2a and device 2b type ambient IoT devices may have less than or equal to a few hundred μW peak power consumption, support energy storage, and use an initial SFO up to 10× ppm. A device 2a type ambient IoT device may communicate uplink transmissions by backscattering externally-provided CWs. A device 2b type ambient IoT device may communicate uplink transmissions by internally generating the uplink transmission.

In some examples, device 1, device 2a, and/or device 2b type ambient IoT devices that are located indoors may support a maximum distance of 10-50 m, a range which may be sub-selected. In Topology 1 (for example, in which an ambient IoT device may directly and bidirectionally communicate with one or more network nodes 110) and in Topology 2 (for example, in which an ambient IoT device may communicate bidirectionally with an intermediate node between the ambient IoT device and a network node 110), device 1, device 2a, and/or device 2b type ambient IoT devices may not support RRC states, mobility (for example, cell-selection/re-selection-like functionality), automatic repeat request (ARQ), or HARQ.

As indicated above, FIG. 3 is provided as an example. Other examples may differ from what is described with regard to FIG. 3.

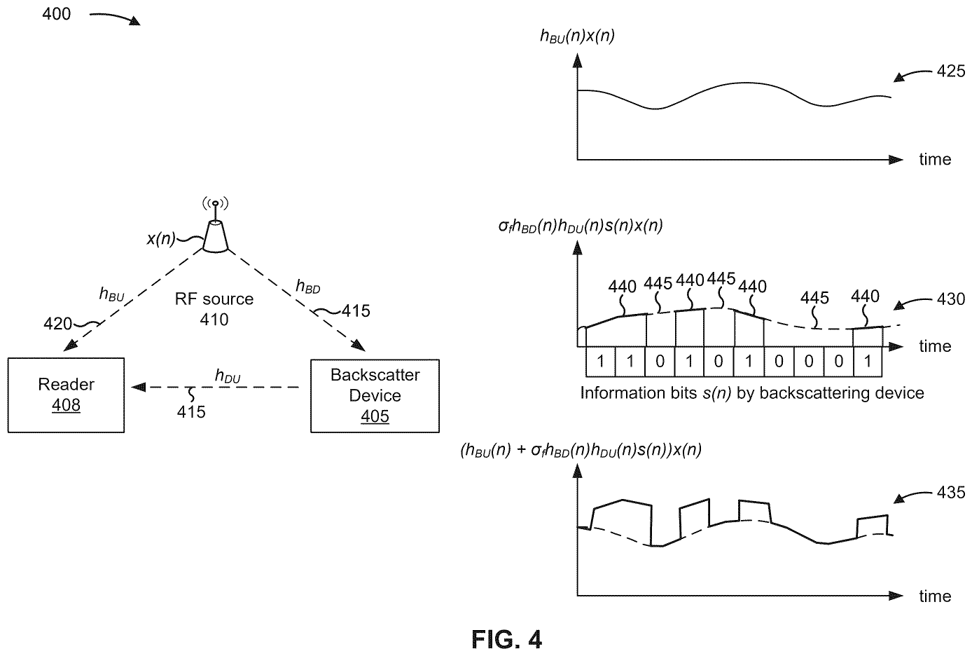

FIG. 4 is a diagram illustrating an example 400 associated with backscatter communications.

Some wireless communication devices may be considered IoT devices, such as ambient IoT devices (sometimes referred to as ultra-light IoT devices), or similar IoT devices. In ambient IoT, a terminal (for example, a radio frequency identification (RFID) device, a tag, or a similar device) may not include a battery, and the terminal may accumulate energy from radio signaling. To achieve further cost reduction and zero-power communication, wireless networks may utilize a type of ambient IoT device referred to as an “ambient backscatter device” or a “backscatter device.”

As shown in FIG. 4, a backscatter device 405 (for example, a tag or a sensor, among other examples), which may be one example of an ambient IoT device such as a passive, semi-passive, or active ambient IoT device described with regard to FIG. 3, may employ a simplified hardware design (for example, including a power splitter, an energy harvester, and a microcontroller) that does not include a battery, such that the backscatter device 405 relies on energy harvesting for power, and that does not include a radio wave generation circuit, such that the backscatter device 405 is capable of transmitting information only by reflecting a radio wave. More particularly, the backscatter device 405 communicates with a reader 408 (for example, a UE 120, a network node 110, or another network device) by modulating a reflecting radio signal from an RF source 410 (for example, a network node 110, a UE 120, or another network device). In some examples, the RF source 410 and the reader 408 may be the same device and/or may be co-located. For example, in some instances, the reader 408 and the RF source 410 may be associated with the same network node 110.

To facilitate communication of the backscatter device 405, the RF source 410 may transmit an energy harvesting wave to the backscatter device 405. The energy harvesting wave may be transmitted for a sufficient duration in order to enable a communication phase for a target range between the reader 408 and the backscatter device 405. Additionally or alternatively, in some instances, a range between the RF source 410 and the backscatter device 405 may be limited by a minimum received power for triggering energy harvesting at the backscatter device 405, such as −20 dBm.

Once energy is sufficiently accumulated at the backscatter device 405, the backscatter device 405 may begin to reflect the radio wave that is radiated onto the backscatter device 405 via a backscatter link 415. For example, the RF source 410 may initiate a communication session (sometimes referred to as a query-response communication) with a query, which may be a modulating envelope of a CW. The backscatter device 405 may respond by backscattering of the CW. The communication session may include multiple rounds, such as for purposes of contention resolution when multiple backscatter devices respond to a query. A channel between the RF source 410 and the backscatter device 405 of the backscatter link 415 may be associated with a first backscatter link channel response value (sometimes referred to as a first backscatter link channel coefficient or a first backscatter link gain value), hBD. As described below, the backscatter device 405 may have reflection-on periods and reflection-off periods that follow a pattern that is based at least in part on the transmission of information bits by the backscatter device 405. The reader 408 may detect the reflection pattern of the backscatter device 405 and obtain the backscatter communication information via the backscatter link 415. A channel between the reader 408 and the backscatter device 405 of the backscatter link 415 may be associated with a second backscatter link channel response value (sometimes referred to as a second backscatter link channel coefficient or a second backscatter link channel gain value), hDU. In addition, the RF source 410 and the reader 408 may communicate (for example, reference signals and/or data signals) via a direct link 420. A channel between the RF source 410 and the reader 408 of the direct link 420 may be associated with a direct link channel response value (sometimes referred to as a direct link channel coefficient or a direct link channel gain value), hBU shown by reference number 425.

Thus, the resulting signal received at the reader 408, which is the superposition of the signal received via the direct link 420 and the signal received via the backscatter link 415, may be denoted as y(n). This signal, y(n), is shown by reference number 435. As shown, when s(n)=0 (indicated by reference number 440 in the plot shown at reference number 430), the backscatter device 405 may switch off reflection, and thus the reader 408 receives only the direct link 420 signal. When s(n)=1 (indicated by reference number 445 in the plot shown at reference number 430), the backscatter device 405 may switch on reflection, and thus the reader 408 receives a superposition of both the direct link 420 signal and the backscatter link 415 signal. To receive the information bits transmitted by the backscatter device 405, the reader 408 may first decode x(n) based at least in part on the direct link channel response value of hBU(n) by treating the backscatter link 415 signal as interference. The reader 408 may then detect the existence of the signal component.

Wireless power transfer uses electromagnetic fields to transfer power from a first device to a second device without the use of a wired connection between the devices. One example of wireless power transfer includes a network node that transmits a power signal that is received and used by an ambient IoT device to harvest energy. The transmission of a power signal between devices for wireless power transfer may also be referred to as a power link. In some cases, energy harvesting by an ambient IoT device may have a reduced range relative to wireless communications. For instance, a wireless power transfer range between a network node and an ambient IoT device may be a few meters (e.g., 10 meters) due to insufficient link budget, and the insufficient link budge may be based at least in part on a variety of factors, such as receiver sensitivity, fading (e.g., due to reflections by multi-path), path loss, and/or antenna gain (e.g., at the ambient IoT device). The reduced range for a power link may hinder the operation of the ambient IoT device when the reduced range results in reducing an amount of energy and/or power that is harvested by the ambient IoT device. To illustrate, less harvest power at the ambient IoT device may increase a charging duration at the ambient IoT device (e.g., a duration in which the ambient IoT device may be inoperable) and/or reduce how often the ambient IoT device has enough power to perform operations and/or communications. Alternatively, or additionally, energy harvesting circuitry may be configured to harvest energy using power signals that have a higher input power level (e.g., characterized by a high power level threshold, such as −13 dBm) and power signals that have a lower input power level (e.g., characterized by a low power level threshold, such as −20 dBm) may render the energy harvesting circuitry, and consequently the ambient IoT device, inoperable. In some cases, a power signal with a low input power level may have a reduced conversion efficiency (e.g., below 1%) that not only wastes power at a network node, but extends a charging duration at the ambient IoT device.

Multiple network nodes may be deployed around an ambient IoT device to increase power transfer coverage based at least in part on an overlap between respective power signals by the multiple network nodes. However, increasing a number of network nodes to increase power transfer coverage may not always result in an increase in harvested energy for some ambient IoT devices. Some examples include an ambient device that resides at an edge of the power transfer coverage and/or an ambient IoT device positioned behind an obstruction that blocks a direct line-of-sight to the network node(s). Without coordination between the network nodes for power transfer coverage to the ambient IoT device, the ambient IoT device may continue to harvest energy at a slower rate and, in some cases, may fail to harvest energy. As described above, a slower rate of energy harvesting, and/or failing to harvest energy, may hinder the operation of the ambient IoT device by reducing how often the ambient IoT device may perform operations and/or communications that use the harvested energy.

Various aspects relate generally to a UE-initiated power signal that uses multiple network nodes. Some aspects more specifically relate to a UE triggering multiple network nodes to coordinate a power transfer to a UE (e.g., an ambient IoT device), resulting in coherence gain in a power signal and, consequently, an increase an effective received power level of the power signal at the UE (e.g., relative to a power transfer signal that is transmitted by a standalone network node and is not a joint transmission by multiple network nodes). In some aspects, a UE, such as an ambient IoT device, may transmit one or more requests to initiate transmission of a multiple-network-node power signal that uses a first network node and at least a second network node. To illustrate, the UE may receive a first indication of the first network node and/or that the first network node is a potential first power supplier to the UE and a second indication of the second network node and/or that the second network node is a potential second power supplier to the UE. Accordingly, the UE may initiate a request to one or more of the network nodes to coordinate and transmit a multiple-network-node power signal. Based at least in part on transmitting the request(s), the UE may receive a multiple-network-node power signal uses the first network node and at least the second network node.

In some aspects, a first network node may receive a request to initiate transmission of a multiple-network-node power signal that uses the first network node and at least a second network node. For instance, the first network node may receive the request from a UE, and the request may identify one or more network nodes to coordinate for the multiple-network-node power signal. Accordingly, based at least in part on receiving the request, the first network node may communicate with at least the second network node to coordinate the transmission of the multiple-network-node power signal. As one example, the first network node may communicate with at least the second network node using backhaul link and/or may indicate, via the backhaul link, to coordinate transmission of a multiple-network-node power signal to the ambient IoT device. The first network node may transmit at least a portion of the multiple-network-node power signal based at least in part on communicating with at least the second network node. To illustrate, the first network node and at least the second network node may transmit the multiple-network-node power transfer signal as an SFN transmission in which the respective power transfer signals share one or more of the same time-frequency resources.

Particular aspects of the subject matter described in this disclosure can be implemented to realize one or more of the following potential advantages. In some examples, by transmitting a request to initiate transmission of a multiple-network-node power signal, the described techniques can be used to enable a UE (e.g., an ambient IoT device) to identify network nodes that are within power transfer coverage of the UE and trigger coordination between the network nodes to generate the multiple-network-node power signal in a manner that increases a coherence gain of the power signal and, consequently, a power level of a received power signal at the UE (e.g., relative to a power signal that is not a joint transmission and/or an SFN transmission). Increasing the effective received power level at the UE may enable the UE to harvest energy at a faster rate and, consequently, increase how often the UE may perform operations and/or perform communications that use the harvested energy.

As indicated above, FIG. 4 is provided as an example. Other examples may differ from what is described with regard to FIG. 4.

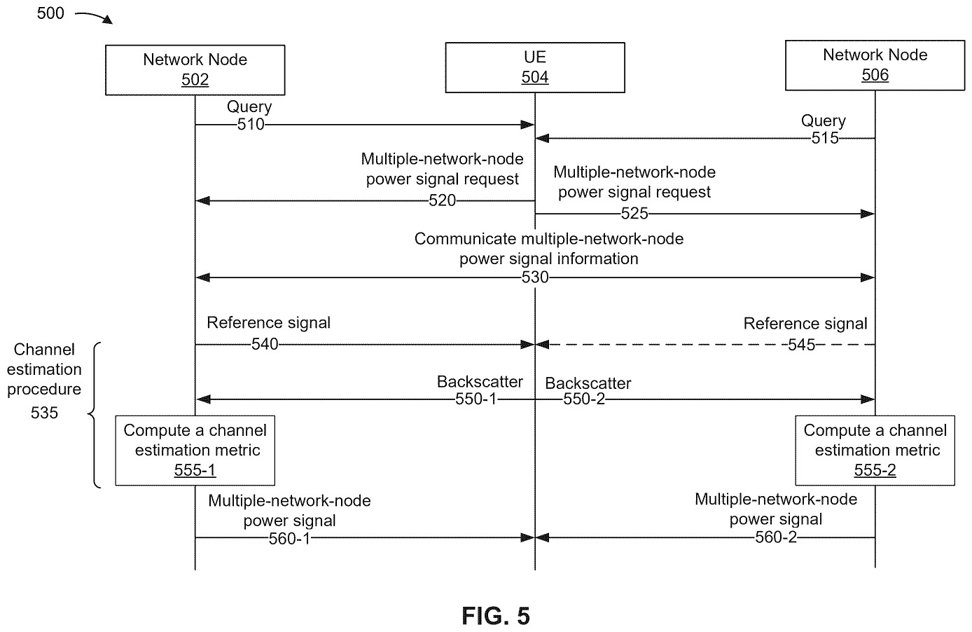

FIG. 5 is a diagram illustrating an example 500 of a wireless communication process between a first network node 502 (e.g., a first network node 110), a UE 504 (e.g., a UE 120 and/or an ambient IoT device as described with regard to FIG. 3 and FIG. 4), and a second network node 506, in accordance with the present disclosure. For clarity, the example 500 includes two network nodes, but other examples may include more than two network nodes.

As shown by reference number 510, a first network node 502 may transmit, and a UE 504 may receive, a first query message. Alternatively, or additionally, as shown by reference number 515, a second network node 506 may transmit, and the UE 504 may receive, a second query message. Each query message may be a respective instance of periodic messaging by the respective network node. While the example 500 includes the first network node 502 transmitting a first query message and the second network node 506 transmitting a second query message, other examples may alternatively, or additionally, include the first network node 502 transmitting a PSS (e.g., periodically) and/or the second network node 506 transmitting a PSS. The UE 504 may identify the first network node 502 and/or at least the second network node 506 using a respective query message and/or a respective PSS transmitted by the respective network node. Alternatively, or additionally, the UE 504 may identify the associated network node as a power supplier to the UE 504 (e.g., via a presence of a power signal, a query message, and/or a PSS).

As one example, the first query message and/or the second query message may be part of a query-response communication as described with regard to FIG. 4, and each query message may include a respective network node identifier (ID). To illustrate, the first network node 502 may be associated with a first network node-specific ID (e.g., assigned to the first network node 502 by a network operator), and the second network node 506 may be associated with a second network node-specific ID (e.g., assigned to the second network node 506 by the network node operator). Each network node may indicate the respective network node-specific ID in the respective query message. In some aspects, the UE 504 may include a capability to receive and decode multiple query messages from multiple network nodes such that the UE 504 may receive the first query message and/or the second query message and recover a respective network node-specific ID indicated in the respective query message.

As a second example, the UE 504 may receive a first PSS from the first network node 502 and/or a second PSS from the second network node 506. In a scenario in which the UE 504 receives a respective PSS from each network node, each PSS may be based at least in part on a respective PSS sequence, and the UE 504 may use the PSS sequence as an identifier for the respective network node (e.g., a PSS ID). That is, the UE 504 may use the respective PSS sequences to differentiate between multiple network nodes (e.g., the first network node 502 and at least the second network node 506).

As shown by reference number 520, the UE 504 may transmit, and the first network node 502 may receive, a multiple-network-node power signal request message. Alternatively, or additionally, as shown by reference number 525, the UE 504 may transmit, and the second network node 506 may receive, a multiple-network-node power signal request message. In some aspects, the UE 504 may transmit a single multiple-network-node power signal request message to one of multiple network nodes identified by the UE 504 (e.g., one of the first network node 502 and at least the second network node 506), while in other aspects, the UE 504 may transmit a multiple-network-node power signal request message to each identified network node. For instance, the UE 504 may transmit a multiple-network-node power signal request message in backscatter that is associated with a query message, a PSS transmission, and/or another transmission by a network node. Alternatively, or additionally, the UE 504 may transmit a multiple-network-node power signal request message as a UE-initiated uplink triggered message. “UE-initiated uplink triggered message” denotes an autonomous transmission by a UE upon completion of energy harvesting (e.g., when the UE has stored enough power to transmit an autonomous message).

The UE 504 may transmit one or more multiple-network-node power signal request messages based at least in part on determining that current power signal(s) received by the UE 504 are associated with a low-efficiency power transfer to the UE 504 (e.g., below an efficiency threshold, such as a 1% efficiency threshold, a 5% efficiency threshold, and/or a 10% efficiency threshold). An efficiency threshold may be based at least in part on one or more signal characteristics. For instance, as described above, the UE 504 may be an ambient IoT device that receives one or more power signals from multiple network nodes, and the UE 504 may determine that the power signals, individually or collectively, are low-efficiency power transfers. As one example, the UE 504 may measure a duration a charging period (e.g., how long it takes the UE 504 to harvest enough energy to perform an operation and/or a communication) and may identify a low-efficiency power transfer based at least in part on the duration satisfying a low-efficiency time threshold. As another example, the UE 504 may measure a power level of a power signal and may identify the low-efficiency power transfer based at least in part on the power level satisfying a low-efficiency power threshold. The UE 504 may determine to request a multiple-network-node power signal to increase an efficiency of the power transfer (e.g., through coherent combining of multiple signals).

In some aspects, the UE 504 may indicate one or more network nodes in multiple-network-node power signal request message. That is, the UE 504 may request particular network nodes to participate in a multiple-network-node power signal. For example, the UE 504 may embed and/or indicate, in the multiple-network-node power signal request message, a respective network node identifier (e.g., the network node-specific ID) for each network node that is associated with a request for a multiple-network-node power signal. Alternatively, or additionally, the UE 504 may embed and/or indicate, in the multiple-network-node power signal request message, a respective PSS sequence (e.g., a PSS ID) that is associated with each respective network node associated with the request for a multiple-network-node power signal.

As shown by reference number 530, the first network node 502 and at last the second network node 506 may communicate multiple-network-node power signal information. As one example, the first network node 502 may communicate with at least the second network node 506 using a backhaul link as described with regard to FIG. 2. In some aspects, the first network node 502 may determine to communicate with at least the second network node 506 based at least in part on the multiple-network-node power signal request message indicating an identifier associated with the second network node 506. In other aspects, the first network node 502 may determine to communicate with at least the second network node 506 based at least in part on location information of the UE 504 and/or the second network node 506, such as by determining that the second network node 506 operates within a distance threshold of the UE 504 (e.g., 20 meters).

The first network node 502 may indicate, to the second network node 506 (and/or vice versa), that the UE 504 has requested a multiple-network-node power signal. Alternatively, or additionally, the first network node 502 may indicate to at least the second network node 506 (and/or vice versa) to perform a channel estimation procedure. As described below with regard to reference number 535, reference number 540, reference number 545, reference number 550-1, reference number 550-2, reference number 555-1, and reference number 555-2, some aspects of a channel estimation procedure may be based at least in part on a joint transmission of a reference signal by the first network node 502 and the second network node 506 (e.g., an SFN transmission), while other aspects of a channel estimation procedure may be based at least in part on one of the first network node 502 and at least the second network node 506 transmitting the reference signal as a standalone network node and/or without using a joint transmission.

The first network node 502 and at least the second network node 506 may communicate any combination of timing information, frequency information, and/or resource information. To illustrate, the first network node 502 and at least the second network node 506 may communicate resource information for transmitting the reference signal as a joint transmission and/or an SFN transmission. Alternatively, or additionally, the first network node 502 and at least the second network node 506 may negotiate which network node will transmit the reference signal as the standalone network node (e.g., as a single transmission and not a joint transmission). In some aspects, the first network node 502 and at least the second network node 506 may communicate a frequency shift that the UE 504 is instructed to apply to backscatter that is based at least in part on the reference signal and/or a carrier frequency of the reference signal. To illustrate, the first network node 502 and/or at least the second network node 506 may instruct the UE 504 to apply a frequency shift and/or may indicate a value for the frequency shift in a query communication that is transmitted prior to transmission of the reference signal. The first network node 502 and at least the second network node 506 may negotiate the frequency shift and/or one network node may select and communicate the frequency shift to the other network node.

As shown by reference number 535 the first network node 502 and/or the second network node 506 may perform a channel estimation procedure. As part of the channel estimation procedure, the first network node 502 may transmit, and the UE 504 may receive, a reference signal as shown by reference number 540. Alternatively, or additionally, the second network node 506 may transmit, and the UE 504 may receive, a reference signal as shown by reference number 545. As described below, the reference signal may be an SFN transmission or a standalone transmission. Accordingly, FIG. 5 illustrates the reference signal transmission by at least the second network node 506 as being optional through the use of a dashed line.

As one example, the first network node 502 and at least the second network node 506 may each operate in a full duplex mode that enables each network node to transmit a reference signal and receive backscatter contemporaneously and/or simultaneously. Based at least in part on each network node operating in a full duplex mode, the first network node 502 and at least the second network node 506 may transmit a reference signal as a joint transmission and/or an SFN transmission based at least in part on using one or more same air interface resources (e.g., one or more same time-frequency resources) and/or a same carrier frequency. The use of an SFN transmission and/or a joint transmission for the reference signal may increase a received signal quality at the UE 504 (e.g., by increasing a received signal power at the UE 504), resulting in an increased signal-to-noise ratio (SNR) that leads to a more accurate channel estimation, and a more accurate channel estimation may enable the first network node 502 and at least the second network node 506 to generate a joint power signal transmission and/or an SFN power signal transmission with higher coherence.

As a second example, the first network node 502 and/or at least the second network node 506 may operate in a half-duplex mode in which a network node alternates between transmission and reception (e.g., does not transmit and receive simultaneously). Accordingly, one network node may transmit the reference signal as a standalone network node (e.g., not as a joint reference signal transmission and/or not as an SFN reference signal transmission). The transmitting network node may be one of the multiple network nodes identified in the multiple-network-node signal power request and/or a network node other than the first network node 502 and at least the second network node 506, such as infrastructure network node as described with regard to FIG. 2, Based at least in part on operating in a half-duplex mode, the transmitting network node may not receive backscatter as described below, may not generate a channel estimation, and/or may not participate in transmitting a multi-network-node power signal.

In some aspects, prior to transmitting the reference signal, the first network node 502 and/or at least the second network node 506 may instruct the UE 504 to apply a frequency shift to backscatter that is associated with and/or generated from the reference signal. Alternatively, or additionally, the first network node 502 and/or at least the second network node 506 may indicate a value for the frequency shift. The first network node 502 and/or the second network node 506 may indicate the frequency shift and/or an instruction to apply the frequency shift in a query communication prior to transmitting the reference signal. The first network node 502 and/or the second network node 506 may transmit an indication of the frequency shift (and/or to use the frequency shift) based at least in part on receiving the multiple-network-node signal power request and/or based at least in part on determining to perform a channel estimation procedure.

As part of the channel estimation procedure, as shown by reference number 550-1, the UE 504 may transmit, and the first network node 502 may receive, backscatter that is based at least in part on the reference signal. Alternatively, or additionally, the UE 504 may transmit, and the second network node 506 may receive, backscatter that is based at least in part on the reference signal as shown by reference number 550-2. The backscatter received by the first network node 502 and at least the second network node 506 may originate from a same backscatter signal. That is, the UE 504 may generate one backscatter signal that is received by multiple network nodes. The UE 504 may apply a frequency shift to the backscatter, such as a frequency shift indicated by the first network node 502 and/or the second network node 506.

As shown by reference number 555-1, the first network node 502 may a channel estimation using the backscatter. Alternatively, or additionally, as shown by reference number 555-2, the second network node 506 may compute a channel estimation using the backscatter.

As a first example, in a scenario in which the first network node 502 and at least the second network node 506 operate in a full duplex mode, each network node may receive the backscatter and may compute a respective channel estimation using the backscatter. For instance, each network node may compute a respective channel estimation using the backscatter and based at least in art on an equation:

$$k - th received backscatter signal = ( {\sum }_{i} {h}_{i}^{f} x ) {h}_{k}^{b} + noise ∝ {h}_{k}^{b} \qquad ( 1 )$$

where x is the signal transmitted by each network node (e.g., a joint reference signal transmission and/or an SFN reference signal transmission),

$${h}_{i}^{f}$$

is a forward channel gain from an i-th transmit network node to a UE (e.g., the UE 504),

$${\sum }_{i} {h}_{i}^{f} x + noise$$

is a received signal at the UE (e.g., the UE 504 and based at least in part on the reference signal), and

$${h}_{k}^{b}$$

is a backward channel gain from the UE (e.g., the UE 504) to the k-th receive network node.

As a second example, in a scenario in which the first network node 502 and at least the second network node 506 operate in a half-duplex mode, all network nodes, except the transmitting network node, may receive the backscatter. Each receiving network node may compute a respective channel estimation using the backscatter and based at least in part on an equation:

$$k - th received backscatter signal = ( {h}_{g n b}^{f} ) {h}_{k}^{b} x + noise ∝ {h}_{k}^{b} \qquad ( 2 )$$

where x is the signal transmitted by the transmitting network node,

$${h}_{g n b}^{f}$$

is a forward channel gain from the transmitting network node to a UE (e.g., the UE 504),

$${h}_{g n b}^{f} x + noise$$

is a received signal at the UE (e.g., the UE 504 and based at least in part on the reference signal), and

$${h}_{k}^{b}$$

is a backward channel gain from the UE (e.g., the UE 504) to a k-th receiving network node.

As shown by reference number 560-1, the first network node 502 may transmit, and the UE 504 may receive, at least a first portion of a multiple-network-node power signal. Alternatively, or additionally, as shown by reference number 560-2, the second network node 506 may transmit, and the UE 504 may receive, at least a second portion of a multiple-network-node power signal. For example, the first network node 502 and at least the second network node 506 may transmit the multi-network node power signal as a joint transmission and/or as an SFN transmission.

In transmitting the first portion of the multiple-network-node power signal and/or the second portion of the multiple-network-node power signal, the first network node 502 and/or at least the second network node 506 may use information derived from the channel estimation described with regard to reference number 555-1 and reference number 555-2 to increase a coherence gain of the multiple-network-node power signal. As one example, the first network node 502 may use beamforming to transmit the first portion using first beamforming weights that are selected based at least in part on a channel estimation computed by the first network node 502. The first beamforming weights may be selected to increase an SNR of a received signal at the UE 504. In a similar manner, the second network node 506 may use beamforming to transmit the second portion using second beamforming weights that are selected based at least in part on a channel estimation computed by the second network node 506 (e.g., to increase an SNR of a received signal at the UE 504). Alternatively, or additionally, the first network node 502 and at least the second network node 506 may transmit the multiple-network-node power signal using a carrier frequency of the reference signal and/or the carrier frequency of the backscatter from the UE 504 (e.g., the carrier frequency of the reference signal and the frequency shift).

In some aspects, a network node may option out of participating in transmission of multiple-network-node power signal. For instance, if a received power level of backscatter at a network node fails to satisfy a qualifying power threshold (e.g., −20 dBm), the network node may option out of participating in multiple-network-node power signal. To illustrate, the received power level failing to satisfy the qualifying power threshold may indicate that the UE 504 is not located within power coverage of the network node.

A UE requesting a multiple-network-node power signal may enable a UE (e.g., an ambient IoT device) to identify network nodes that are within power transfer coverage of the UE and trigger coordination between the network nodes to generate a power signal (e.g., a multiple-network-node power signal) in a manner that increases a gain coherence. Increasing a gain coherence of a power signal may lead to an effective received power level of a received power signal at the UE, and increasing the effective received power level at the UE may enable the UE to harvest energy at a faster rate and, consequently, increase an amount of time the UE may perform operations and/or perform communications that use the harvested energy.

As indicated above, FIG. 5 is provided as an example. Other examples may differ from what is described with regard to FIG. 5.

FIG. 6 is a diagram illustrating an example process 600 performed, for example, at a UE or an apparatus of a UE, in accordance with the present disclosure. Example process 600 is an example where the apparatus or the UE (e.g., UE 120) performs operations associated with UE-initiated power signal that uses multiple network nodes.

As shown in FIG. 6, in some aspects, process 600 may include transmitting one or more requests to initiate transmission of a multiple-network-node power signal that uses a first network node and at least a second network node (block 610). For example, the UE (e.g., using transmission component 804 and/or communication manager 806, depicted in FIG. 8) may transmit one or more requests to initiate transmission of a multiple-network-node power signal that uses a first network node and at least a second network node, as described above with regard to FIG. 5 (e.g. reference number 520 and reference number 525).

As further shown in FIG. 6, in some aspects, process 600 may include receiving the multiple-network-node power signal that uses the first network node and at least the second network node (block 620). For example, the UE (e.g., using reception component 802 and/or communication manager 806, depicted in FIG. 8) may receive the multiple-network-node power signal that uses the first network node and at least the second network node, as described above with regard to FIG. 5 (e.g., reference number 560-1 and reference number 560-2).

Process 600 may include additional aspects, such as any single aspect or any combination of aspects described below and/or in connection with one or more other processes described elsewhere herein.

In a first aspect, process 600 includes receiving a first indication of the first network node, receiving a second indication of at least the second network node, and selecting the first network node and at least the second network node for the multiple-network-node power signal based at least in part on the first indication and the second indication.

In a second aspect, the first indication includes at least one of a first query message that includes a first network node ID that is associated with the first network node, or a first PSS that is associated with the first network node, and the second indication includes at least one of a second query message that includes a second network node ID that is associated with the second network node, or a second PSS that is associated with the second network node.

In a third aspect, transmitting the one or more requests includes transmitting the one or more requests based at least in part on an uplink trigger transmission.

In a fourth aspect, transmitting the one or more requests includes transmitting the one or more requests using backscatter.

In a fifth aspect, the backscatter is based at least in part on a periodic query message from at least one of the first network node, or the second network node.

In a sixth aspect, the one or more requests include at least one of a first indication of the first network node, or a second indication of at least the second network node.

In a seventh aspect, the first indication or the second indication includes at least one of a respective network node identifier of the first network node or at least the second network node, or a respective PSS identifier that is associated with the first network node or at least the second network node.

In an eighth aspect, process 600 includes generating a backscatter signal based at least in part on a reference signal.

In a ninth aspect, the reference signal is associated with the first network node and at least the second network node.

In a tenth aspect, the reference signal is associated with one of the first network node and at least the second network node.

In an eleventh aspect, generating the backscatter signal includes applying a frequency shift to the backscatter signal.

In a twelfth aspect, process 600 includes receiving an indication of the frequency shift from the first network node or at least the second network node.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, at a first network node or an apparatus of a first network node, in accordance with the present disclosure. Example process 700 is an example where the apparatus or the first network node (e.g., first network node 110) performs operations associated with UE-initiated power signal that uses multiple network nodes.

As shown in FIG. 7, in some aspects, process 700 may include receiving a request to initiate transmission of a multiple-network-node power signal that uses the first network node and at least a second network node (block 710). For example, the first network node (e.g., using reception component 902 and/or communication manager 906, depicted in FIG. 9) may receive a request to initiate transmission of a multiple-network-node power signal that uses the first network node and at least a second network node, as described above with regard to FIG. 5 (e.g., reference number 520).

As further shown in FIG. 7, in some aspects, process 700 may include communicating with at least the second network node to coordinate the transmission of the multiple-network-node power signal (block 720). For example, the first network node (e.g., using reception component 902, transmission component 904, and/or communication manager 906, depicted in FIG. 9) may communicate with at least the second network node to coordinate the transmission of the multiple-network-node power signal, as described above with regard to FIG. 5 (e.g., reference number 530).

As further shown in FIG. 7, in some aspects, process 700 may include transmitting at least a portion of the multiple-network-node power signal based at least in part on the communicating (block 730). For example, the first network node (e.g., using transmission component 904 and/or communication manager 906, depicted in FIG. 9) may transmit at least a portion of the multiple-network-node power signal based at least in part on the communicating, as described above with regard to FIG. 5 (e.g., reference number 560-1).

Process 700 may include additional aspects, such as any single aspect or any combination of aspects described below and/or in connection with one or more other processes described elsewhere herein.

In a first aspect, process 700 includes transmitting an indication of an identity of the first network node.

In a second aspect, the indication of the identity includes a network node ID that is associated with the first network node, the network node ID included in a query message, or a PSS that is associated with the first network node.

In a third aspect, receiving the request includes receiving the request in an uplink trigger transmission.

In a fourth aspect, receiving the request includes receiving the request in backscatter.

In a fifth aspect, the backscatter is based at least in part on a periodic query message from the first network node.

In a sixth aspect, the request includes at least one of a first indication of the first network node, or a second indication of at least the second network node.

In a seventh aspect, the first indication or the second indication includes at least one of a respective network node identifier of the first network node or at least the second network node, or a respective PSS identifier that is associated with the first network node or at least the second network node.

In an eighth aspect, process 700 includes transmitting a reference signal that is directed toward a UE, receiving a backscatter signal that is based at least in part on the reference signal, and computing a channel estimation using the backscatter signal.

In a ninth aspect, communicating with at least the second network node includes communicating reference signal configuration information that enables the first network node to transmit the reference signal in a coordinated manner with at least the second network node.

In a tenth aspect, the reference signal configuration information indicates a time-frequency resource assigned to the reference signal, and transmitting the reference signal includes transmitting the reference signal in coordination with at least the second network node using the time-frequency resource, the reference signal including a single frequency network transmission.

In an eleventh aspect, the reference signal is not a single frequency network transmission, and transmitting the reference signal includes transmitting the reference signal as a standalone network node.

In a twelfth aspect, process 700 includes receiving a backscatter signal that is based at least in part on a reference signal that is not transmitted by the first network node, and computing a channel estimation using the backscatter signal.

In a thirteenth aspect, transmitting at least the portion of the multiple-network-node power signal includes transmitting at least the portion of the multiple-network-node power signal as at least part of a single frequency network transmission and in coordination with at least the second network node.

In a fourteenth aspect, process 700 includes selecting a carrier frequency of the multiple-network-node power signal based at least in part on a channel estimation procedure.

In a fifteenth aspect, process 700 includes beamforming the multiple-network-node power signal using one or more beamforming weights that are based at least in part on a channel estimation procedure.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication, in accordance with the present disclosure. The apparatus 800 may be a UE, or a UE may include the apparatus 800. In some aspects, the apparatus 800 includes a reception component 802, a transmission component 804, and/or a communication manager 806, which may be in communication with one another (for example, via one or more buses and/or one or more other components). In some aspects, the communication manager 806 is the communication manager 150 described in connection with FIG. 1. As shown, the apparatus 800 may communicate with another apparatus 808, such as a UE or a network node (such as a CU, a DU, an RU, or a base station), using the reception component 802 and the transmission component 804. The communication manager 806 may be included in, or implemented via, a processing system (for example, the processing system 140 described in connection with FIG. 1) of the UE.

In some aspects, the apparatus 800 may be configured to perform one or more operations described herein in connection with FIGS. 4-5. Additionally, or alternatively, the apparatus 800 may be configured to perform one or more processes described herein, such as process 600 of FIG. 6, or a combination thereof. In some aspects, the apparatus 800 and/or one or more components shown in FIG. 8 may include one or more components of the UE described in connection with FIG. 1. Additionally, or alternatively, one or more components shown in FIG. 8 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications, and may provide the processed signals to the one or more other components of the apparatus 800. In some aspects, the reception component 802 may include one or more components of the UE described above in connection with FIG. 1, such as a radio, one or more RF chains, one or more transceivers, or one or more modems, each of which may in turn be coupled with one or more antennas of the UE.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications, and may transmit the processed signals to the apparatus 808. In some aspects, the transmission component 804 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 804 may be co-located with the reception component 802.

The communication manager 806 may support operations of the reception component 802 and/or the transmission component 804. For example, the communication manager 806 may receive information associated with configuring reception of communications by the reception component 802 and/or transmission of communications by the transmission component 804. Additionally, or alternatively, the communication manager 806 may generate and/or provide control information to the reception component 802 and/or the transmission component 804 to control reception and/or transmission of communications.

The transmission component 804 may transmit one or more requests to initiate transmission of a multiple-network-node power signal that uses a first network node and at least a second network node. The reception component 802 may receive the multiple-network-node power signal that uses the first network node and at least the second network node.

The reception component 802 may receive a first indication of the first network node. Alternatively, or additionally, the reception component 802 may receive a second indication of at least the second network node. In some aspects, the communication manager 806 may select the first network node and at least the second network node for the multiple-network-node power signal based at least in part on the first indication and the second indication.

The communication manager 806 may generate a backscatter signal based at least in part on a reference signal. In some aspects, reception component 802 may receive an indication of the frequency shift from the first network node or at least the second network node.

The number and arrangement of components shown in FIG. 8 are provided as an example. In practice, there may be additional components, fewer components, different components, or differently arranged components than those shown in FIG. 8.

Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a diagram of an example apparatus 900 for wireless communication, in accordance with the present disclosure. The apparatus 900 may be a network node, or a network node may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 155 described in connection with FIG. 1. As shown, the apparatus 900 may communicate with another apparatus 908, such as a UE or a network node (such as a CU, a DU, an RU, or a base station), using the reception component 902 and the transmission component 904. The communication manager 906 may be included in, or implemented via, a processing system (for example, the processing system 145 described in connection with FIG. 1) of the network node.

In some aspects, the apparatus 900 may be configured to perform one or more operations described herein in connection with FIGS. 4-5. Additionally, or alternatively, the apparatus 900 may be configured to perform one or more processes described herein, such as process 700 of FIG. 7, or a combination thereof. In some aspects, the apparatus 900 and/or one or more components shown in FIG. 9 may include one or more components of the network node described in connection with FIG. 1. Additionally, or alternatively, one or more components shown in FIG. 9 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications, and may provide the processed signals to the one or more other components of the apparatus 900. In some aspects, the reception component 902 may include one or more components of the network node described above in connection with FIG. 1, such as a radio, one or more RF chains, one or more transceivers, or one or more modems, each of which may in turn be coupled with one or more antennas of the network node. In some aspects, the reception component 902 and/or the transmission component 904 may include or may be included in a network interface. The network interface may be configured to obtain and/or output signals for the apparatus 900 via one or more communications links, such as a backhaul link, a midhaul link, and/or a fronthaul link.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications, and may transmit the processed signals to the apparatus 908. In some aspects, the transmission component 904 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 904 may be co-located with the reception component 902.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The reception component 902 may receive a request to initiate transmission of a multiple-network-node power signal that uses the first network node and at least a second network node. The reception component 902 and/or the transmission component 904 may communicate with at least the second network node to coordinate the transmission of the multiple-network-node power signal. The transmission component 904 may transmit at least a portion of the multiple-network-node power signal based at least in part on the communicating.

The transmission component 904 may transmit an indication of an identity of the first network node. Alternatively, or additionally, the transmission component 904 may transmit a reference signal that is directed toward a UE.

The reception component 902 may receive a backscatter signal that is based at least in part on the reference signal. In some aspects, the reception component 902 may receive a backscatter signal that is based at least in part on a reference signal that is not transmitted by the first network node. The communication manager 906 may compute a channel estimation using the backscatter signal.

The communication manager 906 may select a carrier frequency of the multiple-network-node power signal based at least in part on a channel estimation procedure. Alternatively, or additionally, the communication manager 906 may beamform the multiple-network-node power signal using one or more beamforming weights that are based at least in part on a channel estimation procedure.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:
Aspect 1: A method of wireless communication performed by a user equipment (UE), comprising: transmitting one or more requests to initiate transmission of a multiple-network-node power signal that uses a first network node and at least a second network node; and receiving the multiple-network-node power signal that uses the first network node and at least the second network node.
Aspect 2: The method of Aspect 1, further comprising: receiving a first indication of the first network node; receiving a second indication of at least the second network node; and selecting the first network node and at least the second network node for the multiple-network-node power signal based at least in part on the first indication and the second indication.
Aspect 3: The method of Aspect 2, wherein the first indication comprises at least one of: a first query message that includes a first network node identifier (ID) that is associated with the first network node, or a first primary synchronization signal (PSS) that is associated with the first network node, and wherein the second indication comprises at least one of: a second query message that includes a second network node ID that is associated with the second network node, or a second PSS that is associated with the second network node.
Aspect 4: The method of any of Aspects 1-3, wherein transmitting the one or more requests comprises: transmitting the one or more requests based at least in part on an uplink trigger transmission.
Aspect 5: The method of any of Aspects 1-4, wherein transmitting the one or more requests comprises: transmitting the one or more requests using backscatter.
Aspect 6: The method of Aspect 5, wherein the backscatter is based at least in part on a periodic query message from at least one of: the first network node, or the second network node.
Aspect 7: The method of any of Aspects 1-6, wherein the one or more requests include at least one of: a first indication of the first network node, or a second indication of at least the second network node.
Aspect 8: The method of Aspect 7, wherein the first indication or the second indication comprises at least one of: a respective network node identifier of the first network node or at least the second network node, or a respective primary synchronization signal identifier that is associated with the first network node or at least the second network node.
Aspect 9: The method of any of Aspects 1-8, further comprising: generating a backscatter signal based at least in part on a reference signal.
Aspect 10: The method of Aspect 9, wherein the reference signal is associated with the first network node and at least the second network node.
Aspect 11: The method of Aspect 9 or Aspect 10, wherein the reference signal is associated with one of the first network node and at least the second network node.
Aspect 12: The method of any one of Aspects 9-11, wherein generating the backscatter signal comprises: applying a frequency shift to the backscatter signal.
Aspect 13: The method of Aspect 12, further comprising: receiving an indication of the frequency shift from the first network node or at least the second network node.
Aspect 14: A method of wireless communication performed by a first network node, comprising: receiving a request to initiate transmission of a multiple-network-node power signal that uses the first network node and at least a second network node; communicating with at least the second network node to coordinate the transmission of the multiple-network-node power signal; and transmitting at least a portion of the multiple-network-node power signal based at least in part on the communicating.
Aspect 15: The method of Aspect 14, further comprising: transmitting an indication of an identity of the first network node.
Aspect 16: The method of Aspect 15, wherein the indication of the identity comprises: a network node identifier (ID) that is associated with the first network node, the network node ID included in a query message, or a primary synchronization signal that is associated with the first network node.
Aspect 17: The method of any of Aspects 14-16, wherein receiving the request comprises: receiving the request in an uplink trigger transmission.
Aspect 18: The method of any of Aspects 14-17, wherein receiving the request comprises: receiving the request in backscatter.
Aspect 19: The method of Aspect 18, wherein the backscatter is based at least in part on a periodic query message from the first network node.
Aspect 20: The method of any of Aspects 14-19, wherein the request includes at least one of: a first indication of the first network node, or a second indication of at least the second network node.
Aspect 21: The method of Aspect 20, wherein the first indication or the second indication comprise at least one of: a respective network node identifier of the first network node or at least the second network node, or a respective primary synchronization signal identifier that is associated with the first network node or at least the second network node.
Aspect 22: The method of any of Aspects 14-21, further comprising: transmitting a reference signal that is directed toward a user equipment (UE); receiving a backscatter signal that is based at least in part on the reference signal; and computing a channel estimation using the backscatter signal.
Aspect 23: The method of Aspect 22, wherein communicating with at least the second network node comprises: communicating reference signal configuration information that enables the first network node to transmit the reference signal in a coordinated manner with at least the second network node.
Aspect 24: The method of Aspect 23, wherein the reference signal configuration information indicates a time-frequency resource assigned to the reference signal, and wherein transmitting the reference signal comprises: transmitting the reference signal in coordination with at least the second network node using the time-frequency resource, the reference signal comprising a single frequency network transmission.
Aspect 25: The method of Aspect 22, wherein the reference signal is not a single frequency network transmission, and wherein transmitting the reference signal comprises: transmitting the reference signal as a standalone network node.
Aspect 26: The method of any of Aspects 14-25, further comprising: receiving a backscatter signal that is based at least in part on a reference signal that is not transmitted by the first network node; and computing a channel estimation using the backscatter signal.
Aspect 27: The method of any of Aspects 14-26, wherein transmitting at least the portion of the multiple-network-node power signal comprises: transmitting at least the portion of the multiple-network-node power signal as at least part of a single frequency network transmission and in coordination with at least the second network node.
Aspect 28: The method of Aspect 27, further comprising: selecting a carrier frequency of the multiple-network-node power signal based at least in part on a channel estimation procedure.
Aspect 29: The method of Aspect 27 or Aspect 28, further comprising: beamforming the multiple-network-node power signal using one or more beamforming weights that are based at least in part on a channel estimation.
Aspect 30: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-13.
Aspect 31: An apparatus for wireless communication at a device, the apparatus comprising one or more memories and one or more processors coupled to the one or more memories, the one or more processors configured to cause the device to perform the method of one or more of Aspects 1-13.
Aspect 32: An apparatus for wireless communication, the apparatus comprising at least one means for performing the method of one or more of Aspects 1-13.
Aspect 33: A non-transitory computer-readable medium storing code for wireless communication, the code comprising instructions executable by one or more processors to perform the method of one or more of Aspects 1-13.
Aspect 34: A non-transitory computer-readable medium storing a set of instructions for wireless communication, the set of instructions comprising one or more instructions that, when executed by one or more processors of a device, cause the device to perform the method of one or more of Aspects 1-13.
Aspect 35: A device for wireless communication, the device comprising a processing system that includes one or more processors and one or more memories coupled with the one or more processors, the processing system configured to cause the device to perform the method of one or more of Aspects 1-13.
Aspect 36: An apparatus for wireless communication at a device, the apparatus comprising one or more memories and one or more processors coupled to the one or more memories, the one or more processors individually or collectively configured to cause the device to perform the method of one or more of Aspects 1-13.
Aspect 37: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 14-29.
Aspect 38: An apparatus for wireless communication at a device, the apparatus comprising one or more memories and one or more processors coupled to the one or more memories, the one or more processors configured to cause the device to perform the method of one or more of Aspects 14-29.
Aspect 39: An apparatus for wireless communication, the apparatus comprising at least one means for performing the method of one or more of Aspects 14-29.
Aspect 40: A non-transitory computer-readable medium storing code for wireless communication, the code comprising instructions executable by one or more processors to perform the method of one or more of Aspects 14-29.
Aspect 41: A non-transitory computer-readable medium storing a set of instructions for wireless communication, the set of instructions comprising one or more instructions that, when executed by one or more processors of a device, cause the device to perform the method of one or more of Aspects 14-29.
Aspect 42: A device for wireless communication, the device comprising a processing system that includes one or more processors and one or more memories coupled with the one or more processors, the processing system configured to cause the device to perform the method of one or more of Aspects 14-29.
Aspect 43: An apparatus for wireless communication at a device, the apparatus comprising one or more memories and one or more processors coupled to the one or more memories, the one or more processors individually or collectively configured to cause the device to perform the method of one or more of Aspects 14-29.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a +b+c, as well as any combination with multiples of the same element (for example, a +a, a+a +a, a+a +b, a+a +c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories; and
one or more processors, coupled to the one or more memories, the one or more processors configured, individually or collectively, to cause the UE to:
transmit one or more requests to initiate transmission of a multiple-network-node power signal that uses a first network node and at least a second network node; and
receive the multiple-network-node power signal that uses the first network node and at least the second network node.

2. The apparatus of claim 1, wherein the one or more processors are further configured, individually or collectively, to cause the UE to:
receive a first indication of the first network node;
receive a second indication of at least the second network node; and
select the first network node and at least the second network node for the multiple-network-node power signal based at least in part on the first indication and the second indication.

3. The apparatus of claim 2, wherein the first indication comprises at least one of:
a first query message that includes a first network node identifier (ID) that is associated with the first network node, or
a first primary synchronization signal (PSS) that is associated with the first network node, and
wherein the second indication comprises at least one of:
a second query message that includes a second network node ID that is associated with the second network node, or
a second PSS that is associated with the second network node.

4. The apparatus of claim 1, wherein the one or more processors, to cause the UE to transmit the one or more requests, are configured, individually or collectively, to cause the UE to:
transmit the one or more requests based at least in part on an uplink trigger transmission.

5. The apparatus of claim 1, wherein the one or more processors, to cause the UE to transmit the one or more requests, are configured, individually or collectively, to cause the UE to:
transmit the one or more requests using backscatter.

6. The apparatus of claim 1, wherein the one or more requests include at least one of:
a first indication of the first network node, or
a second indication of at least the second network node.

7. The apparatus of claim 6, wherein the first indication or the second indication comprises at least one of:
a respective network node identifier of the first network node or at least the second network node, or
a respective primary synchronization signal identifier that is associated with the first network node or at least the second network node.

8. The apparatus of claim 1, wherein the one or more processors are further configured, individually or collectively, to cause the UE to:
generate a backscatter signal based at least in part on a reference signal.

9. The apparatus of claim 8, wherein the one or more processors, to cause the UE to generate the backscatter signal, are configured, individually or collectively, to cause the UE to:
apply a frequency shift to the backscatter signal.

10. The apparatus of claim 9, wherein the one or more processors are further configured, individually or collectively, to cause the UE to:
receive an indication of the frequency shift from the first network node or at least the second network node.

11. A method of wireless communication performed by a user equipment (UE), comprising:
transmitting one or more requests to initiate transmission of a multiple-network-node power signal that uses a first network node and at least a second network node; and
receiving the multiple-network-node power signal that uses the first network node and at least the second network node.

12. The method of claim 11, further comprising:
receiving a first indication of the first network node;
receiving a second indication of at least the second network node; and
selecting the first network node and at least the second network node for the multiple-network-node power signal based at least in part on the first indication and the second indication.

13. The method of claim 11, wherein transmitting the one or more requests comprises:
transmitting the one or more requests based at least in part on an uplink trigger transmission.

14. The method of claim 11, wherein transmitting the one or more requests comprises:
transmitting the one or more requests using backscatter.

15. The method of claim 11, further comprising:
generating a backscatter signal based at least in part on a reference signal.

16. The method of claim 15, wherein generating the backscatter signal comprises:
applying a frequency shift to the backscatter signal.

17. A non-transitory computer-readable medium storing a set of instructions for wireless communication, the set of instructions comprising:
one or more instructions that, when executed by one or more processors of a user equipment (UE), cause the UE to:
transmit one or more requests to initiate transmission of a multiple-network-node power signal that uses a first network node and at least a second network node; and
receive the multiple-network-node power signal that uses the first network node and at least the second network node.

18. The non-transitory computer-readable medium of claim 17, wherein the one or more instructions further cause the UE to:
receive a first indication of the first network node;
receive a second indication of at least the second network node; and
select the first network node and at least the second network node for the multiple-network-node power signal based at least in part on the first indication and the second indication.

19. The non-transitory computer-readable medium of claim 17, wherein the one or more instructions further cause the UE to:
generate a backscatter signal based at least in part on a reference signal.

20. The non-transitory computer-readable medium of claim 19, wherein the one or more instructions, that cause the UE to generate the backscatter signal, cause the UE to:
receive an indication of a frequency shift from the first network node or at least the second network node; and
apply the frequency shift to the backscatter signal.
